(19) United States
(12) Patent Application Publication
(10) Pub. No.: US 2016/0055211 A1
(43) Pub. Date: Feb. 25, 2016

(54) APPARATUS AND METHOD FOR MEMORY STORAGE AND ANALYTIC EXECUTION OF TIME SERIES DATA

(71) Applicant: GE Intelligent Platforms, Inc., Charlottesville, VA (US)

(72) Inventors: Brian Scott COURTNEY, Naperville, IL (US); Kareem Sherif AGGOUR, Niskayuna, NY (US); Ward Linnscott BOWMAN, Mendon, MA (US); John Alan INTERRANTE, Scotia, NY (US); Sunil MATHUR, East Walpole, MA (US); Justin DeSpenza MCHUGH, Latham, NY (US); Jenny Marie Weisenberg WILLIAMS, Niskayuna, NY (US)

(21) Appl. No.: 14/777,863

(22) PCT Filed: Mar. 18, 2013
(86) PCT No.: PCT/US2013/032802

§ 371 Date: Sep. 17, 2015

(51) Int. Cl. G06F 17/30; G06F 12/02

(52) U.S. Cl. CPC G06F 17/30483; G06F 12/023; G06F 2212/254

(57) ABSTRACT

A user query or analytic user is received. The user query or analytic requires one or more portions of time series data from a plurality of transient memories. The time series data is linked together across the transient memories devices. A location of one or more portions of the time series data is identified at the plurality of transient memories. One or more portions of the time series data is automatically retrieved from the transient memories.

### CROSS REFERENCES TO RELATED APPLICATIONS

International application no. PCT/US2013/032803 filed Mar. 18, 2013 and published as WO2014149027 A1 on Sep. 25, 2014 and entitled “Apparatus and Method for Optimizing Time Series Data Storage Based Upon Prioritization”;

International application no. PCT/US2013/032810 filed Mar. 18, 2013 and published as WO2014149029 A1 on Sep. 25, 2014 and entitled “Apparatus and Method for Executing Parallel Time Series Data Analytics”;

International application no. PCT/US2013/032823 filed Mar. 18, 2013 and published as WO2014149031 A1 on Sep. 25, 2014 and entitled “Apparatus and Method for Time Series Query Packaging”;

International application no. PCT/US2013/032806 filed Mar. 18, 2013 and published as WO2014149028 A1 on Sep. 25, 2014 and entitled “Apparatus and Method for Optimizing Time Data Storage”;

International application no. PCT/US2013/032801 filed Mar. 18, 2013 and published as WO2014149025 A1 on Sep. 25, 2014 and entitled “Apparatus and Method for Optimizing Time Data Store Usage”;

are being filed on the same date as the present application, the contents of which are incorporated herein by reference in their entireties.

### BACKGROUND OF THE INVENTION

1. Field of the Invention

The subject matter disclosed herein relates to storing time series data and the execution of queries against this data.

2. Brief Description of the Related Art

Data is stored on data storage devices in a variety of different formats. Additionally, various types of data storage devices are used to store data and these data storage devices may vary in cost. In one example, data may be stored according to certain formats on high cost devices such as random access memories (RAMs). In other examples, data may be stored on low cost devices such as on hard disks.

One type of data that is stored is time series data. In one aspect, time series data is obtained by some type of sensor or measurement device and is stored as a function of time. For example, a measurement sensor may take a reading of a parameter at predetermined time intervals, and each of the measurements is stored in memory. Since large amounts of data are typically involved with time series measurements, retrieving the data may become inefficient in some situations.

Traditional on-disk storage systems are not able to provide sufficiently fast access to large volumes of data. In particular, traditional in-memory solutions use the memory of a single machine to store data, and therefore cannot storage large quantities of time series data in memory. This has resulted in user frustration with these previous approaches.

### BRIEF DESCRIPTION OF THE INVENTION

Embodiments of the present invention are provided that store large quantities of time series data in memory for very fast read and write access operations, analytic executions and/or data visualizations (e.g., the display or presentation of data to a user). A single electronic device or machine typically does not have enough capacity to store all of the data one would want available in memory. Embodiments of the present invention overcome this and other problems by utilizing a combined memory across a cluster of devices (e.g., a cluster of multiple servers). The memory of each machine is effectively stitched together to form a single data grid, such that, to users, the time series data appears to be disposed in one single, large in-memory repository. These embodiments provide for linearly scaling the amount of time series data stored in memory by adding or removing hardware nodes in the cluster. A simple mechanism is also provided by which the amount of data that can be stored in memory can be increased or decreased at any point in time.

In other aspects, embodiments of the present invention combine the use of a distributed in-memory data grid with a unique in-memory representation of time series data in order to enable rapid ingestion, storage, and processing of time series data. The in-memory data grid provides reliable storage of large amounts of data by distributing the data across the memories of multiple nodes of the cluster. In one example, the in-memory representation uses a doubly-linked list to store data points for a specific sensor for a specific time span in sorted order, enabling rapid access to the data with the ability to very efficiently walk across the data forward or backward in time.

In many of these embodiments, a read request is received. The user read request requires one or more portions of time series data from a plurality of transient (non-permanent) memories. The time series data is linked together across the transient memories. A location of one or more portions of the time series data is identified at the plurality of transient memories. One or more portions of the time series data is then automatically retrieved from the transient memories.

In some aspects, the time series is linked according to a doubly-linked list. In other aspects, new time series data may be added to the doubly-linked list. In still other aspects, selected time series data can be removed from the doubly-linked list.

In some examples, the transient memories are random access memories (RAMs). In other examples, the time series data is obtained by measurements made by an electronic device. In other of these embodiments, a memory grid includes a plurality of transient memories, a plurality of time series data portions, and an access apparatus. The plurality of time series data portions is disposed in the plurality of transient memories. Each of the plurality of time series data portions indicates a previous portion and a next portion. The indicating occurs between segments and in some cases selectably across and between separate ones of the transient memories.

The access apparatus receives access requests. After reception, a determination is made as to one or more of the time series data portions needed to respond to the request.

In other of these embodiments, a memory grid includes a plurality of transient memories, a plurality of time series data portions, and an access apparatus. The plurality of time series data portions is disposed in the plurality of transient memories. Each of the plurality of time series data portions indicates a previous portion and a next portion. The indicating occurs between segments and in some cases selectably across and between separate ones of the transient memories.

### BRIEF DESCRIPTION OF THE DRAWINGS

For a more complete understanding of the disclosure, reference should be made to the following detailed description and accompanying drawings wherein:

FIG. 1 comprises a block diagram of a system for storing and accessing time series data according to various embodiments of the present invention;

FIG. 2 comprises a block diagram of a system for storing and accessing time series data according to various embodiments of the present invention; and

FIG. 3 comprises a flow chart of an embodiment for storing and accessing time series data according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the embodiments described herein, an in-memory data grid and/or index with a linkage arrangement (e.g., a doubly-linked list) are used to store large quantities of time series data for high speed analytic execution and/or visualization (e.g., the display or presentation of the data to a user). Using these embodiments, time series data can be ingested into memory across the data grid, which automatically partitions and replicates the data across a plurality of transient memories (e.g., a cluster of servers) for fault tolerance. The ingestion process involves binning the data into time buckets for efficient in-memory storage and retrieval. Each “bin” or memory consists of or stores, for example, a doubly-linked list containing time series data for a particular sensor and time span (e.g., one minute). The use of doubly-linked lists for instance allow for insertion of out-of-order data points (in contrast with fixed arrays or ring buffers). Compactness is achieved by reducing the size of each data point (using as few primitive fields as possible) in memory and storing the name of each sensor name only once instead of storing it in each data point.

Execution of high speed analytics and/or visualizations is achieved by writing functions to execute the analytics in the memory of each electronic device (e.g., computer) in the data grid and using the data grid to distribute the analytics. Examples of analytics include, but are not limited to, comparing the current values to recent past values to detect large variations in the current values to identify anomalies, generating averages from the data, or performing interpolation between data points. Alternatively, analytics can be written that execute outside of the data grid while relying on fast queries to extract the relevant data from the grid, and then write the results back to the grid or any other pertinent destination.

Embodiments of the present invention provide faster queries and analytics on time series data than traditional disk-based storage embodiments, and can be utilized to provide better service to customers and thus increased revenue in a variety of ways. In industrial equipment remote monitoring and diagnostic applications, embodiments of the present invention enable problems to be detected and diagnosed faster, potentially preventing equipment failures and outages. Ad-hoc troubleshooting queries (e.g., searching for unusual patterns or trends in the data) can be run in seconds rather than minutes or hours. Real-time visualization capabilities (e.g., the display or presentation of data to the user) can be supported, as well.

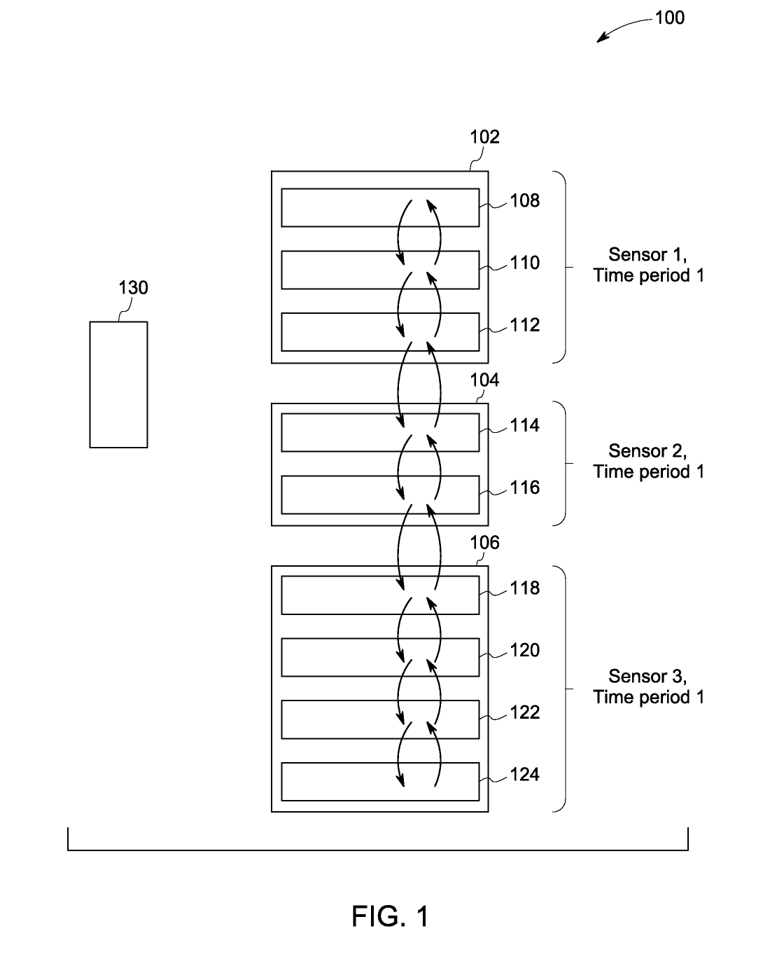

Referring now to FIG. 1, a memory grid includes a plurality of transient memories 102, 104 and 106, a plurality of time series data portions 108, 110, 112, 114, 116, 118, 120 and 122 and an access apparatus 130. The plurality of time series data portions 108, 110, 112, 114, 116, 118, 120 and 122 are disposed in the plurality of transient memories 102, 104, and 106. Each of the plurality of time series data portions 108, 110, 112, 114, 116, 118, 120 and 122 indicate a previous portion and a next portion. The indicating occurs between the time series data portions 108, 110, 112, 114, 116, 118, 120 and 122 and in some cases selectably across and between separate ones of the transient memories 102, 104, and 106. The time series data portions 108, 110, 112, 114, 116, 118, 120 and 122 may be data segments, files, records, or any type of data structure. In one example, the time series data portions 108, 110, 112, 114, 116, 118, 120 and 122 are formed as a doubly linked list.

The access apparatus 130 receives access requests from users. After reception, a determination is made as to one or more of the time series data portions 108, 110, 112, 114, 116, 118, 120 and 122 are needed to respond to the request.

The transient memories 102, 104, and 106 may be any type of memory that temporarily holds data (i.e., data vanishes when power is removed). The time series data portions 108, 110, 112, 114, 116, 118, 120 and 122 are any type of time series data, for example, data obtained periodically by a measurement device.

It can be seen that individual ones of the portions 108, 110, 112, 114, 116, 118, 120 and 122 point to a previous and next portion, for example, according to a doubly-linked list. Other pointing mechanisms can also be used. Thus, new portions of time series data can be inserted and selected portions can be removed easily and quickly from the portions 108, 110, 112, 114, 116, 118, 120 and 122.

In the example of FIG. 1, each of the transient memories 102, 104, and 106 holds time series data from a different sensor (sensors 1, 2, and 3) over the same time period. An index may point to this time series data. Thus, time series data for a particular sensor and a particular time period can be located and retrieved rapidly.

The access apparatus 130 may be located at the transient memories 102, 104, or 106, that includes an index, or the access apparatus 130 can be a separate intermediary device (that includes an index). The access apparatus 130 may be implemented in a variety of different ways. For instance, the access apparatus 130 may be implemented as computer instructions that are executed at a processing device such as a microprocessor or the like.

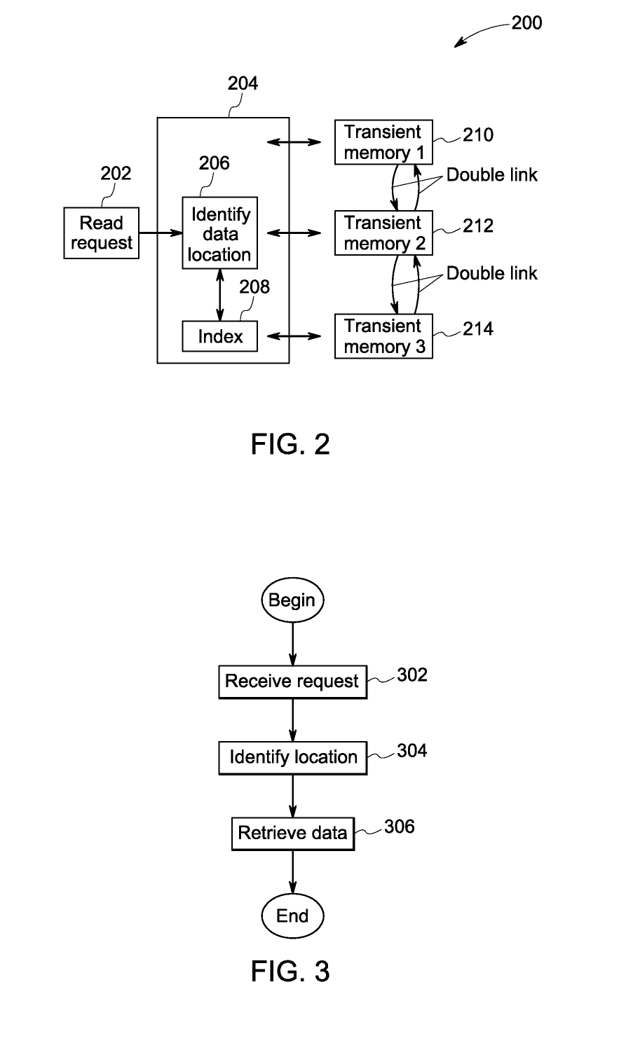

Referring now to FIG. 2, a system 200 for storing an accessing time series is described. The system 200 includes an access apparatus 204 (that includes an identity data location module 206 and an index 208) and a first transient memory 210, a second transient memory 212, and a third transient memory 214.

The first transient memory 210, second transient memory 212, and third transient memory 214 may be, for example, random access memories (RAMs). The first transient memory 210, second transient memory 212, and third transient memory 214 include portions (e.g., segments, records, files, or the like) of time series data (e.g., data obtained by a measurement device over time). Each of the first transient memory 210, second transient memory 212, and third transient memory 214 may hold data from a separate time period, or combinations of different sensors and time periods. The data may be arranged in other ways as well.

Data from each of the memories 210, 212 and 214 are stitched together (e.g., using a doubly-linked list) so that logically, the data is continuous. For instance, separate fields in the doubly-linked list may point to, indicate, or specify, the next record in the doubly-linked list. Additionally, well known programming techniques can be used to insert new records into the doubly-linked list and remove records from the doubly-linked list. It will be appreciated that a doubly-linked list is one example of a data structure that can be used to implement the embodiments described herein and that other structures are possible.

In one example of the operation of FIG. 2, a read request 202 is received by the access apparatus 204. It will be understood that other queries besides read requests can also be received and processed and a read request is used here as an example only.

The access apparatus uses the identity data location module 206 to identify in which of the memories 210, 212, or 214 time series data that is responsive to the request is located. In this respect, the index 208 points to, indicates, or specifies where particular types of data are located. For example, the index 208 will specify that data for a first sensor is located in a particular one of the transient memories 210, 212, or 214. The index 208 may be implemented as any appropriate data structure, but it will be understood that the index 208 may be also implements as computer code and/or hardware as well.

Referring now to FIG. 3, one example of an embodiment for the efficient storage and retrieval of time series data is described. It will be appreciated that the embodiment of FIG. 3 may be implemented in a variety of different ways, for example as computer instructions executed at a processing device.

At step 302, a user read request requires one or more portions of time series data from a plurality of transient memory. The time series data is linked together across the transient memories. At step 304, a location of one or more portions of the time series data is identified at the plurality of transient memories. At step 306, one or more portions of the time series data is automatically retrieved from the transient memories.

In some aspects, the time series is linked according to a doubly-linked list. In other aspects, new time series data may be added to the doubly-linked list. In still other aspects, selected time series data can be removed from the doubly-linked list.

In some examples, the transient memories are random access memories. In other aspects, the time series data is obtained by measurements made by an electronic device. For example, a measurement device on a piece of industrial equipment may obtain a measurement (e.g., a temperature or pressure measurement) and report this measurement.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method for the dynamic retrieval of time series data, the method comprising,
receiving a user read request, the user read request requiring one or more portions of time series data from a plurality of data storage devices, the time series data being linked together across the plurality of data storage devices;
identifying a location of the one or more portions of time series data at the plurality of transient memories using an index;
automatically retrieving the one or more portions of the time series data from the plurality of transient memories.

2. The method of claim 1 wherein the time series data is linked according to a doubly-linked list.

3. The method of claim 2 further comprising inserting new time series data from the doubly-linked list.

4. The method of claim 2 further comprising remaining selected time series data from the doubly-linked list.

5. The method of claim 1 wherein the plurality of transient memories comprise random access memories.

6. The method of claim 1 wherein the time series data is obtained by measurements made by an electronic device.

7. A memory grid configured to store time series data, comprising:
a plurality of transient memories;
a plurality of time series data portions in the plurality of transient memories;
each of the plurality of time series data portions indicating a previous portion and a next portion, the indicating occurring between segments and selectably across the plurality of transient memories;
an access apparatus for receiving an access request and determining one or more of the time series data portions responsive to the request.

8. The memory grid of claim 7 wherein the time series data is linked according to a doubly-linked list.

9. The memory grid of claim 8 wherein the access apparatus inserts new time series data from the doubly-linked list.

10. The memory grid of claim 8 wherein the access apparatus removes selected time series data from the doubly-linked list.

11. The memory grid of claim 7 wherein the plurality of transient memories comprise random access memories.

12. The memory grid of claim 7 wherein the time series data is obtained by measurements made by an electronic device.
